(19) United States
(12) Patent Application Publication
(10) Pub. No.: US 2007/0219764 A1
(43) Pub. Date: Sep. 20, 2007

(54) Synchronized Physical and Analytical Flow System Models

(75) Inventors: Thord Backe, Hopkinton, NH (US); Greg Vazzana, Merrimack, NH (US); Jorgen Dahl, Merrimack, NH (US); Paul Fred DesSureault, Weare, NH (US); Thomas Olsson, Manchester, NH (US); Jason Martin, Pembroke, NH (US)

Correspondence Address: FISH & RICHARDSON P.C., PO BOX 1022, MINNEAPOLIS, MN, 55440-1022, US

(73) Assignee: AUTODESK, INC., San Rafael, CA (US)

(21) Appl. No.: 11/614,049

(22) Filed: Dec. 20, 2006

Related U.S. Application Data
(60) Provisional application No. 60/783,014, filed on Mar. 15, 2006.

(51) Int. Cl. G06G 7/48

(52) U.S. Cl. 703/6

(57) ABSTRACT

Methods and apparatus, including computer program products, for providing a physical computer aided design (CAD) model comprising a plurality of physical objects in a flow system. Each of the plurality of physical objects are joined at one or more physical linkages. An analytical model of the flow system is generated based on the one or more physical linkages. And one of the analytical model or the physical CAD model is automatically updated to reflect a change to the other.

### CROSS-REFERENCE TO RELATED APPLICATIONS

This application claims priority to pending U.S. Patent Application No. 60/783,014, entitled SYNCHRONIZED PHYSICAL AND ANALYTICAL FLOW SYSTEM MODELS, to inventors Thord Backe, et al., which was filed on Mar. 15, 2006. The disclosure of the above application is incorporated herein by reference in its entirety.

### BACKGROUND

Engineers who develop Heating, Ventilation and Air Conditioning (HVAC) systems, piping systems and electrical systems for buildings typically deal with two kinds of models. A physical Computer Aided Design (CAD) model is used for drafting and shows the physical location, connections and size of piping, HVAC, and electrical elements in relation to a building or other structure. An analytical model is used to compute flow rates, the size elements, and the type of equipment needed for the system.

For example, in developing an HVAC system for a building, an engineer will typically start with a building's structural plans, laying out the physical air intake and outtake terminals, the locations of airflow equipment, and the duct work to connect them. This can be a complicated and time consuming process because duct work may need to be routed around columns, walls and other obstructions in the building.

Next, the HVAC system is typically modeled in a separate analysis package or by hand. For example, the engineer can associate airflow requirements with each of the elements in the HVAC system, such as the cubic feet per minute (CFM) that a given duct can transport air and the airflow requirements of rooms served by the HVAC system. This information is used by the analysis package to determine what size airflow equipment is needed to meet the capacity. The results of the analysis can necessitate time consuming modifications to the HVAC system which require the engineer to go back and redraft portions to change the size or location of duct work, the number of air diffusers, or the type and number of pieces of airflow equipment, for example. Moreover, if a change is made to the building's plans, much of the work developing the HVAC system can need to be redone.

### SUMMARY

In general, in one aspect, embodiments of the invention feature providing a physical computer aided design model comprising a plurality of physical objects in a flow system. Each of the plurality of physical objects is joined at one or more physical linkages. An analytical model of the flow system is generated based on the one or more physical linkages. And one of the analytical model or the physical CAD model is automatically updated to reflect a change to the other.

These and other embodiments can optionally include one or more of the following features. The flow system is one of: an airflow system, a fluid flow system or an electrical system. An analysis of the flow system can be performed based on the analytical model. The analysis can include determining flow, static pressure, velocity or pressure loss. A flow system can incorporate one or more flow subsystems. A size for a physical object can be determined in the plurality of physical objects based on one or more of flow velocity, flow friction, or a size constraint. A physical object is one of flow equipment, a diffuser, a return diffuser, an exhaust terminal, an exhaust fan, a duct, a pipe, an electrical cable or a fitting.

In general, in another aspect, embodiments of the invention feature providing a physical computer aided design model of a flow system. The model incorporates one or more flow terminals and one or more rooms. Each of the one or more flow terminals is associated with a room in the one or more rooms. One or more physical connections are automatically routed between the flow system terminals. The flow system is analyzed based on the one or more physical connections and one or more properties of each room.

These and other embodiments can optionally include one or more of the following features. The analyzing utilizes an analytical model. One of the analytical model or the physical CAD model is automatically updated to reflect a change to the other. User input is accepted designating the one or more flow terminals as the flow system. Analyzing can include determining flow, static pressure, velocity or pressure loss for the flow system. The flow system includes flow equipment to provide water or air to, or extract water or air from, the flow system terminals. A room property is one of: required airflow, required water flow, or required electrical current. A flow terminal is one of: a diffuser, a return diffuser, an exhaust terminal, an exhaust fan, a cooling coil or a heating coil. A physical connection is a duct, a pipe, and electrical cable or a fitting. A size for a physical connection is determined in the one or more physical connections based on one or more of flow velocity, flow friction, or a size constraint.

Particular embodiments of the invention can be implemented to realize one or more of the following advantages. Analysis of a physical flow system CAD model is performed by a CAD software tool. An analytical model of a physical flow system CAD model is automatically created. The analytical model and the physical model are automatically synchronized so that changes to one are automatically reflected in the other. Physical objects in the physical model can be automatically sized based on the analytical model. Static pressure, flow, velocity and pressure loss for a physical model of a flow system are automatically determined by the analytical model. Design time is reduced since analysis of the physical model is done in place, as the physical model is created and modified. As a result, engineers can converge on the correct solution quickly by trying out different configurations of a flow system to determine what is optimal and cost effective.

The details of one or more embodiments of the invention are set forth in the accompanying drawings and the description below. Other features, aspects, and advantages of the invention will become apparent from the description, the drawings, and the claims.

### DESCRIPTION OF DRAWINGS

FIG. 1A is a flow diagram illustrating a technique for creating physical and analytical CAD models of a flow system.

FIG. 1B shows an example of a graphical user interface for viewing and manipulating one or more computer aided design models.

FIG. 2 shows an element properties dialog for defining and modifying properties of objects in a physical model.

FIG. 3 shows the addition of flow terminals to rooms.

FIG. 4 shows the addition of flow equipment to a physical model and the designation of a flow system.

FIG. 5A shows automatically generated physical connections based on logical connections between terminals and equipment in a physical model.

FIG. 5B illustrates analytical connection points associated with physical linkages in the physical model of the flow system of FIG. 5A.

FIG. 6 shows an example of a user interface for viewing and manipulating properties of a flow system.

FIG. 7 shows an example properties dialog for viewing and manipulating properties of one or more objects in a physical model of a flow system.

FIG. 8 illustrates return terminals in a flow system.

FIG. 9 shows a further example of the system browser for viewing and manipulating properties of a flow system including return diffusers.

FIG. 10 shows an example of a properties dialog for automatically sizing one or more physical connections in a physical model of a flow system.

FIG. 11 shows automatically generated physical connections along with walls of rooms in a 3D view.

FIG. 12 shows an example of a conversion settings dialog for viewing, manipulating, and defining properties of one or more physical connections.

FIG. 13 shows a physical model of a flow system reflecting new conversion settings.

FIG. 14 shows an example of adding and modifying flexible physical connections.

FIG. 15 shows an example of adding and modifying subsystems of a flow system.

FIG. 16 shows another example of the system browser for viewing and manipulating properties of a flow system including subsystems.

FIG. 17 shows an example of routing automatically generated physical connections.

FIG. 18 shows another example of routing automatically generated physical connections.

FIG. 19 is a system diagram showing an example of a system for viewing and manipulating a model of a flow system.

FIG. 20 is a flow diagram of an example of a process for generating and automatically updating an analytical representation of a flow system.

FIG. 21 is a flow diagram of an example of a process for automatically routing physical connections in a flow system and analyzing the flow system.

Like reference symbols in the various drawings indicate like elements.

### DETAILED DESCRIPTION

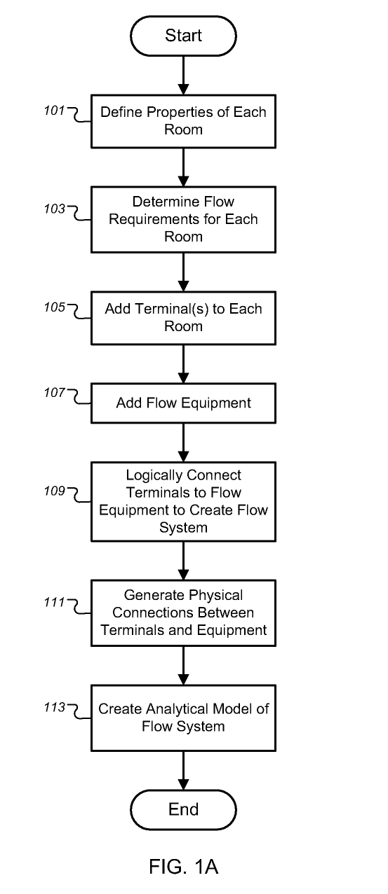

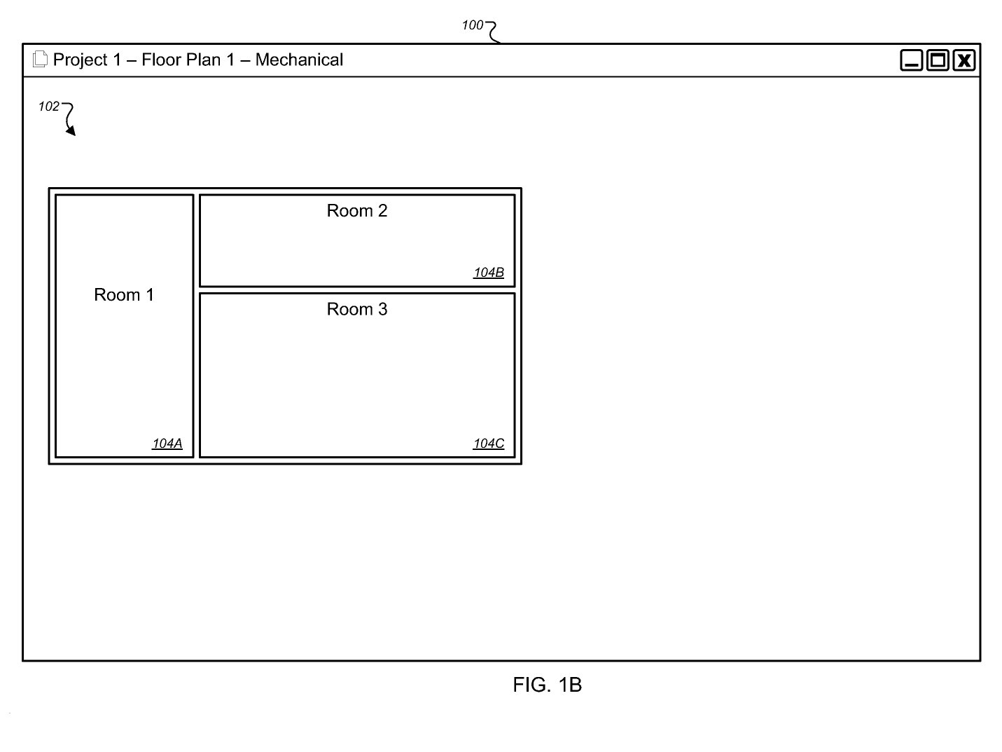

FIG. 1A is a flow diagram illustrating a technique for creating physical and analytical CAD models of a flow system such as an airflow system, fluid flow system or an electrical system. A CAD model can incorporate information required to represent buildings, flow systems and analytical representations of the flow systems. A CAD model can be stored in one or more files, object-oriented databases, relational databases, distributed objects, combinations of these, or other suitable persistent storage. The term “model” as used herein is synonymous with the CAD model's contents.

A user interactively creates one or more rooms with a CAD tool (see FIG. 1B) which are incorporated in a physical CAD model. Alternatively, the physical model can be obtained from an existing CAD model. The rooms can be part of a surrounding structure or exist apart from a surrounding structure. Room properties are defined (step 101). In an airflow system, for example, room properties can include the desired temperature of the room, the number of people occupying the room, the room geometry, the number of windows and doors in the room, and a measure of the room's exposure to sun. Other room properties are possible. Room properties can be automatically calculated based on the configuration of rooms or specified by users.

Based on each room's properties, flow requirements (e.g., required airflow, required water flow, required electrical current) for each room are determined (step 103). In an airflow system, the required airflow for each room would be determined. In one implementation, portion(s) of the physical model representing the rooms can be provided to a third party analysis application for determination of flow requirements. For example, information can be exchanged with an analysis application using the Green Building XML (gbXML) document format. The resultant requirements can then be incorporated into the physical model.

One or more flow terminals can be added to each room either interactively by a user interacting with the CAD tool (e.g., graphical user interface 100) or automatically based on room properties (step 105). Flow terminals are incorporated into the physical model. For airflow, a flow terminal represents a diffuser (e.g., an air vent), a return diffuser, an exhaust terminal, an exhaust fan, a cooling or heating coil, or other heat exchange device used to transfer thermal energy from a fluid to the surrounding air. In one implementation, users can interactively drag and drop graphical representations of terminals in rooms at desired locations.

One or more pieces of flow equipment are added to the physical model automatically based on room properties or interactively as specified by users (step 107). Equipment includes airflow equipment such as HVAC or air supply units, water flow equipment such as pumps, and electrical equipment. In one implementation users can interactively drag and drop graphical representations of equipment at desired locations in a view of the CAD model. New equipment types can be defined by users.

The flow terminals and the flow equipment are logically associated or connected to each other through user interaction or automatically to create a flow system in the physical model (step 109). For example, users can interactively select (e.g., with mouse or keyboard input) the flow terminal(s) and flow equipment they wish to be part of the flow system. Physical connections can be automatically generated between the terminals and the flow equipment in the physical model (step 111). Physical connections can include ducts, pipes, electrical cables, and associated fittings. An analytical model of the flow system in the physical model is automatically created (step 113). The analytical model can determine static pressure, flow, velocity and pressure loss for the flow system and is used to automatically determine the type of flow equipment needed and the physical size of connections joining terminals with flow equipment.

FIG. 1B shows an example of a graphical user interface (GUI) 100 for viewing and manipulating one or more computer aided design (CAD) models. The GUI 100 can be presented by an interactive CAD software tool that allows users to interactively view, create, import, export, and modifying of one or more CAD models. In one implementation, the software application is Autodesk® Revit® Systems, available from Autodesk, Inc. of San Rafael, Calif. The graphical user interface (GUI) 100 can present one or more views of one or more models. View 102 presents a plan view of three room objects 104A, 104B and 104C (or “rooms”) which are represented in a CAD model. Other views are possible. By way of example, a view can be two dimensional (2D), three dimensional (3D), an elevation, a section, a cut away, an analytical view, or combinations of these.

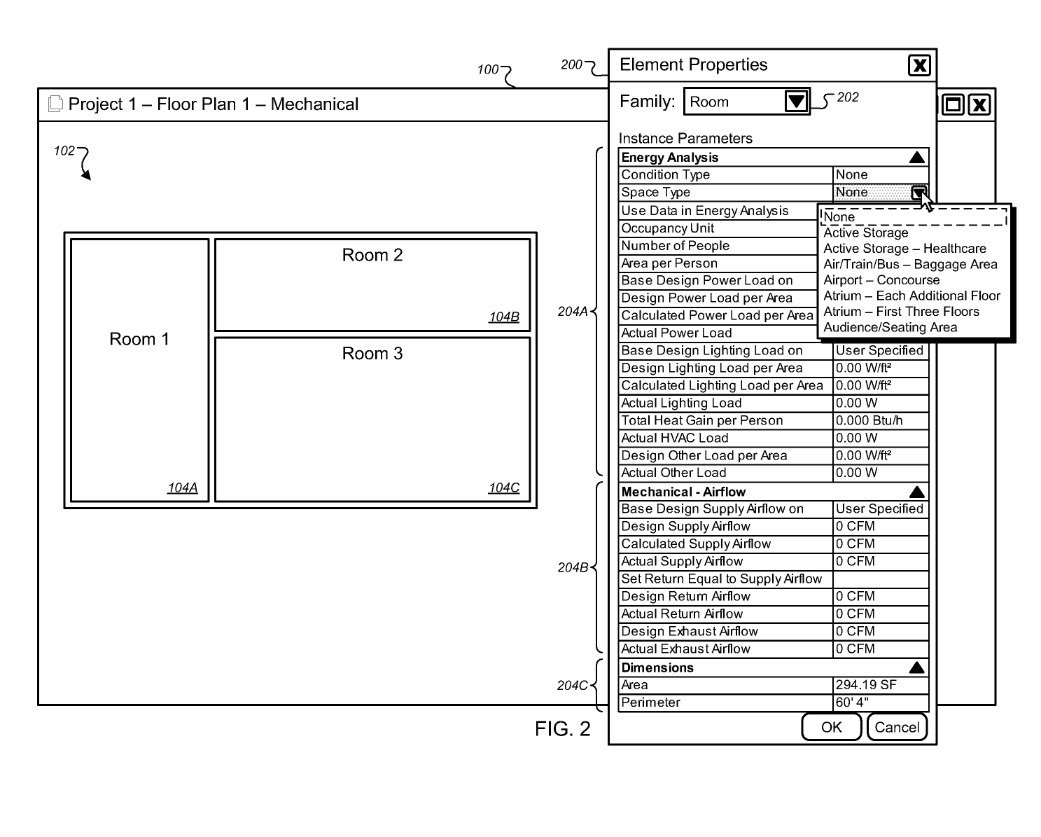

FIG. 2 shows an element properties dialog 200 for defining and modifying properties of objects in a physical CAD model, such as room 104B. For example, users can select an object of interest in the view 102 (e.g., room 104B) and then examine and modify properties of the selected object with dialog 200. The room 104B is classified as a “Room”, as shown in the Family control 202. Properties of the room can be grouped, such as Energy Analysis properties 204A, Mechanical—Airflow properties 204B, and Dimensions properties 204C. Objects in the physical model can have common properties (e.g., dimensions, flow rate) as well as their properties specific to an object type.

In some implementations of flow systems, the properties of objects in the physical model include information necessary to calculate a required flow for each element. For example, the room 104B has properties, such as space type, number of people, area per person, total heat gain per person, area, and perimeter relating to an airflow system. Airflow system properties can include other properties, such as information regarding exterior walls, heating information, cooling information, and regulations regarding energy efficiency. These properties can be used to calculate a required airflow for the room 104B, for example. The required airflow information can be added to the properties of the room 104B, such as in a Calculated Supply Airflow property.

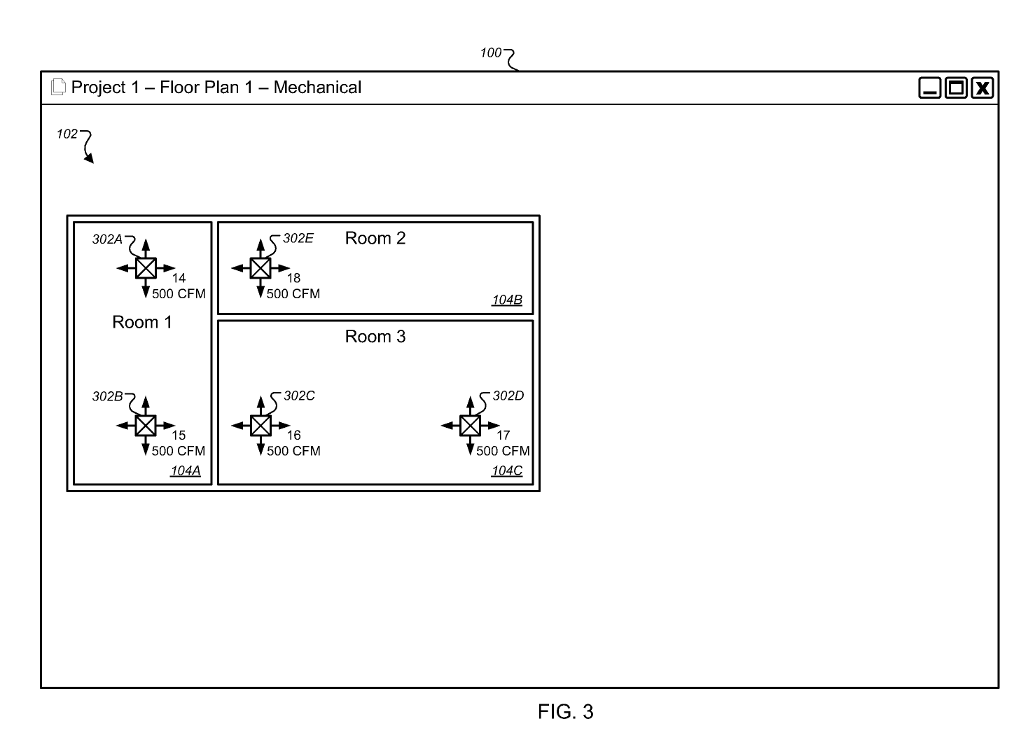

FIG. 3 shows the addition of flow terminals to rooms. Users can interactively add and position one or more flow terminals to one or more rooms. Users can also interactively modify the properties of flow terminals such as, in the case of airflow, changing the flow rate property (e.g., CFM) for the flow terminal. In one implementation, if the flow property of a diffuser is modified, the flow properties of other terminals in the room are automatically adjusted to maintain the required airflow for the room. For example, if room 104A's required airflow rate is 1000 CFM and terminal 302A's airflow rate property is set to 700 CFM, the airflow rate property of terminal 302B can be automatically set to 300 CFM.

A room's properties can be used to automatically determine a number and type of flow terminals to be added to each room. For example, the rooms 104A-C can have required airflow rates of 1000 CFM, 500 CFM, and 1000 CFM, respectively. The supply diffusers 302A-B, each with an airflow of 500 CFM, satisfy the airflow requirements of the room 104A. The supply diffuser 302E (with an airflow of 500 CFM) satisfies the airflow requirement of the room 104B and the supply diffusers 302C-D (each with an airflow of 500 CFM) satisfy the airflow requirement of the room 104C. Diffusers 302A-E can be automatically added to the rooms 104A-C to satisfy the rooms' airflow requirements based on defaults or heuristics guiding the number, flow size and location of diffusers, for example. One such heuristic, for instance, might dictate that a room having a certain area can contain a given number of diffusers spaced apart from each other by a predetermined distance.

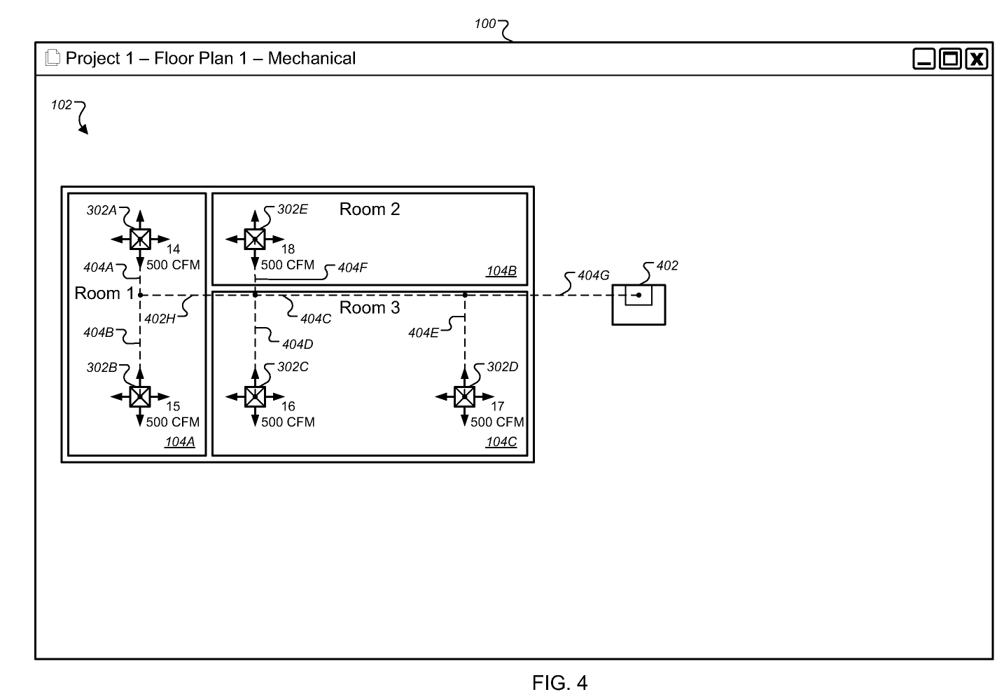

FIG. 4 shows the addition of flow equipment to a physical model and the designation of a flow system. In one implementation, a flow system includes one or more pieces of flow equipment and one or more flow terminals connected to one or more of the flow equipment pieces. One or more pieces of flow equipment 402 can be added to a physical model interactively by users or automatically based on the required flow of one or more rooms. A user can logically connect each flow terminal to a piece of flow equipment or to another flow terminal in order to form a flow system. These logical connections are illustrated with dashed lines in the view 102.

For example, a user can select terminal 302A and then select equipment 402. In response, the view will show dashed lines 404A, 404H, 404C, and 404G connecting terminal 302A to equipment 402 representing the logical connection. If the user next selects terminal 302B and then selects equipment 402, dashed line 404B (connected to 404H) will be displayed. The logical connections will be used to automatically generate physical connections between the objects, such as ducts and corresponding fittings in the case of an airflow system. In one implementation, a flow system can be logically connected to another such that physical connections are automatically generated to connect the two flow systems.

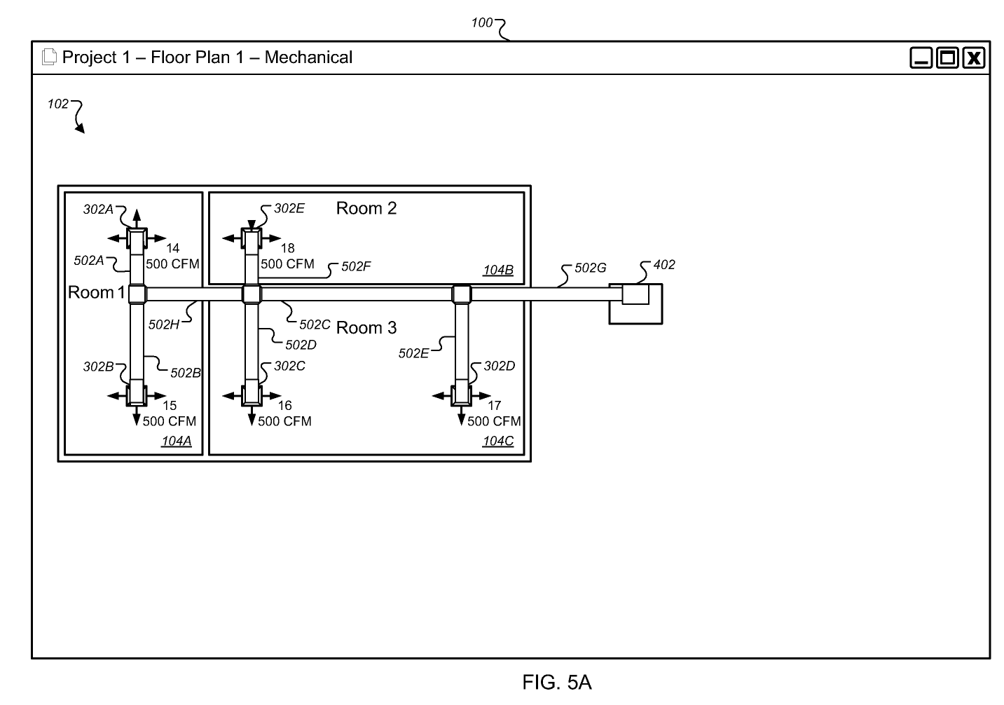

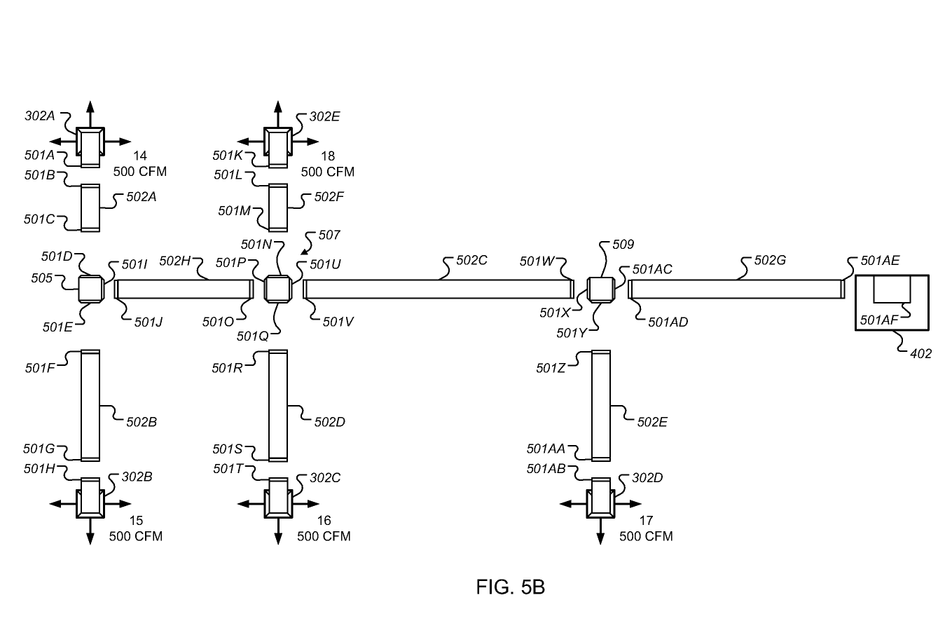

FIG. 5A shows automatically generated physical connections based on logical connections between terminals and equipment in a physical model. The physical connections 502A-H correspond to the logical connections 404A-H, respectively. In the case of an airflow system, the physical connections include ducts (e.g., rigid and flexible) and associated fittings to join the ducts to each other, the terminals 302A-E, and the equipment 402. Fittings are automatically resized to accommodate the objects they are connected to. In a water flow system, the physical connections include pipes and associated fittings.

Default settings can determine how physical connections are routed. For example, the settings can include a default vertical distance that ceiling mounted diffusers are located from a trunk duct or pipe located above a ceiling. The default settings can contain a default type of duct, such as rigid or flexible in the case of airflow systems, and a default size of physical connections. The physical model can contain information about the structure of the building in which the rooms are disposed, such as the location of walls, supports, and other potential obstructions to physical connections. The structure information can be used when automatically routing physical connections to avoid obstructions.

The total flow represented by the terminals 302A-E is automatically calculated. The total flow can be used to determine the capacity of the flow equipment 402 needed for the flow system. For example, the total supply airflow represented by the supply diffusers 302A-E is 2500 CFM. An HVAC or Air Handling Unit (AHU) 402 can be chosen that is capable of providing 2500 CFM. In one implementation, the required equipment capacity is used to automatically select the equipment 402.

Each flow system object (e.g., terminals, physical connections, equipment) represented in the physical model is joined to one or more other flow system objects through one or more physical linkages. For example, a duct has physical linkages at either end of the duct. One of the duct's physical linkages can be connected to a diffuser's physical linkage so that air will flow between the two. The duct's other physical linkage can be connected to the physical linkage of a fitting, such as a tee joint. The remaining two physical linkages on the tee joint can be used to join with the physical linkages of two additional ducts, for example.

The analytical model of the flow system represents the physical model of the flow system using logical connection points that correspond to physical linkages between each flow system object represented in the physical model. Alternatively, there can be more or fewer connection points than physical linkages. A connection point represents the properties of its corresponding physical linkage (e.g., flow rate, flow velocity, flow friction, static pressure, location, geometry, and other suitable properties). The analytical model works backwards from the room terminals to the equipment, propagating the connection point properties from one connection point to another to ultimately determine the type of equipment needed (e.g., type of fan, size of motor) to satisfy the capacity of the flow system based on the overall static pressure and overall flow, for example. Alternatively, the analytical model can analyze a flow system from the equipment to the room terminals. The analytical model is automatically updated to reflect changes to the physical model, such as the addition or deletion of objects or changes to object properties.

FIG. 5B illustrates analytical connection points associated with physical linkages in the physical model of the flow system of FIG. 5A. The connection points are used by the analytical model to analyze the flow system. By way of illustration, connection point 501A has a flow rate property equal to the flow rate property of the terminal 302A (i.e., 500 CFM). The flow rate property of connection point 501A is propagated to the connection point 501B of duct 502A, and then to connection point 501C of duct 502A. The connection points for terminal 302B and duct 502B are also determined in this manner. There are three connection points for tee connector 505. The flow rate property of connection point 501C is propagated to connection point 501D. The flow rate property of connection point 501F (also 500 CFM) is propagated to connection point 501E. The flow rate property of the third connection point 501I for the tee connector 505 represents the sum of the flow rate properties of connection points 501D and 501E. Therefore, connection point 501I has a flow rate property equal to 1000 CFM. Similarly, the flow rate of 1000 CFM propagates to connection points 501J, 501O, and 501P.

Cross connector 507 receives 1000 CFM of flow from the connection point 501P. The cross connector 507 also receives 500 CFM of flow from the terminal 302E via connection points 501K, 501L, 501M, and 501N. The cross connector 507 receives another 500 CFM of flow from the terminal 302C via connection points 501T, 501S, 501R, and 501Q. Therefore, the total flow rate through the cross connector 507 is 2000 CFM. The 2000 CFM flow rate is propagated from the cross connector 507 to connection points 501U, 501V, 501W, and 501X.

Tee connector 509 receives 2000 CFM of flow from the connection point 501X. The tee connector 509 receives another 500 CFM of flow from the terminal 302D via connection points 501AB, 501AA, 501Z, and 501Y. Therefore, the total flow rate through the tee connector 509 is 2500 CFM. The 2500 CFM flow rate is propagated from the tee connector 509 to connection points 501AC, 501 AD, 501AE, and 501AF, where it can be used to determine the type of equipment 402 required.

In some implementations, a user can modify properties of connection points in the analytical model by selecting representations of them in the view and editing their properties. For example, the process may be similar to the method described above for editing the properties of an object in a physical model. A change made to an analytical model may be automatically reflected in its corresponding physical model and vice versa. For example, if the flow rate of connection point 501H is increased in the analytical model, then duct 502B, the tee connector 505, and the other ductwork connecting to the flow equipment 402 may be automatically resized to accommodate the change.

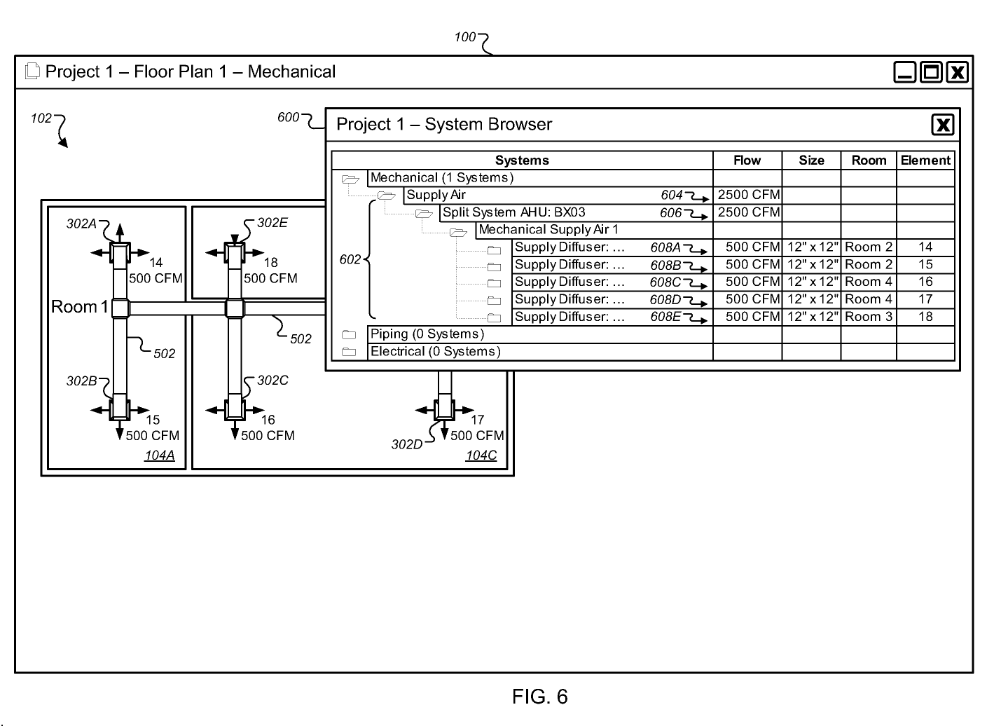

FIG. 6 shows an example of a user interface 600 for viewing and manipulating properties of a flow system. The interface 600 includes a hierarchical representation 602 of the airflow system shown in the view 102. The representation 602 includes the total supply flow 604 represented by the supply diffusers 302A-E, the supply flow capability 606 of the equipment 402, and the individual supplies 608A-E of the terminals 302A-E, respectively. The total supply flow 604 can be used, for example, to chose an appropriate piece of flow equipment for the flow system. For example, a user can verify that flow equipment satisfies the total supply flow represented by the supply diffusers in a flow system.

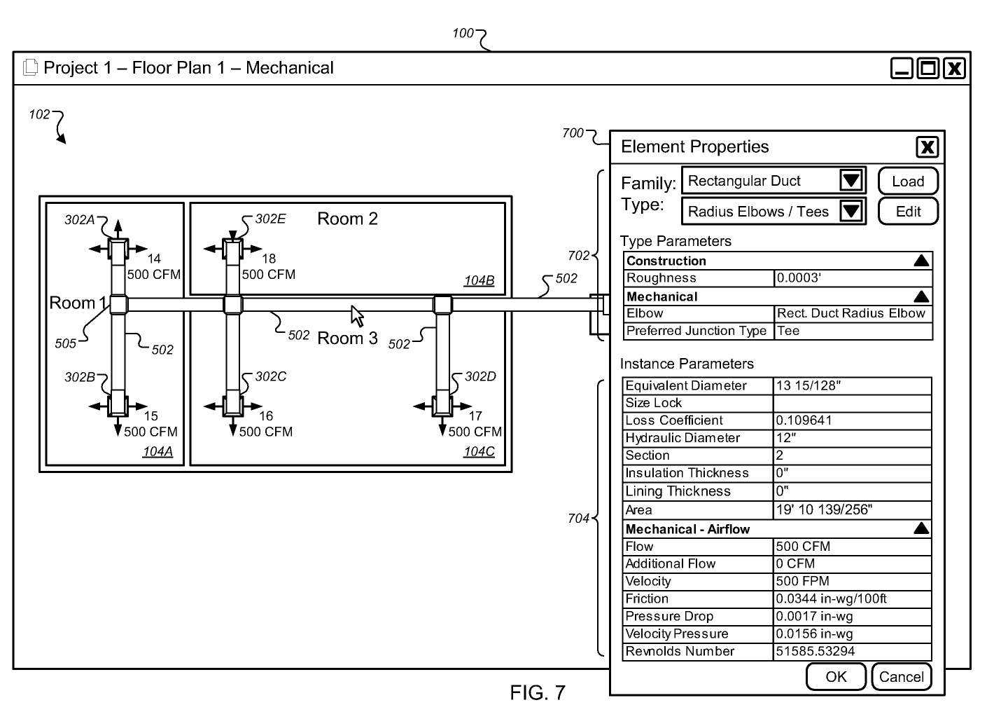

FIG. 7 shows an example properties dialog 700 for viewing and manipulating properties of one or more objects in a physical model of a flow system. Here, a user has selected the duct 502. The interface 700 presents properties of the selected object 502. The properties include type properties 702 that can be common to objects of that type and instance properties 704 that can be specific to the selected instance of the object. For example, the type properties 702 can include an object family of “Rectangular Duct” and a type of “Radius Elbows/Tees.” The instance properties 704 can include, for example, an airflow capability of the object, an air velocity capability of the object, friction within the object, and pressure information within the object. For example, users can modify the airflow capability of tee 505. Object properties can be stored in the physical model.

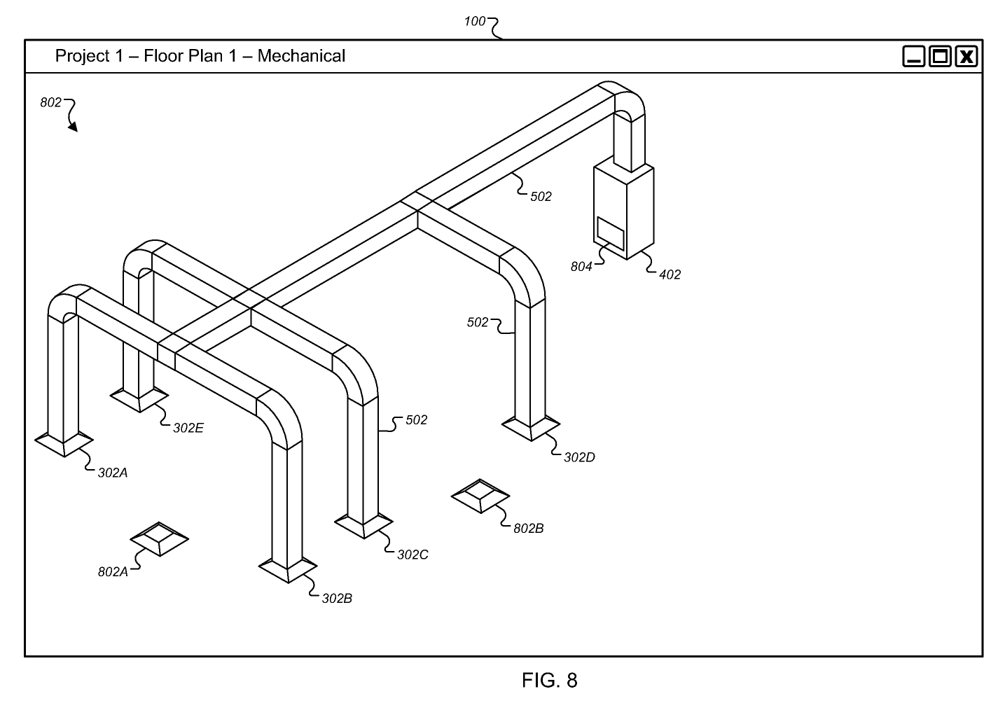

FIG. 8 illustrates return terminals in a flow system. View 802 provides a 3D perspective view of a physical model. Return air diffusers 802A-B have been added to the physical model. In addition, the equipment 402 now shows a physical linkage 804 for joining with a return airflow system. The user can specify logical connections between the return diffusers 802A-B and the equipment 402 from which the physical connections can be generated automatically, in a manner similar to the discussion above regarding the supply airflow system. For example, users can select the terminals 802A-B and equipment 402 and logically associate them as a return airflow system. Required physical connections between the terminals 802A-B and equipment 402 are then automatically generated.

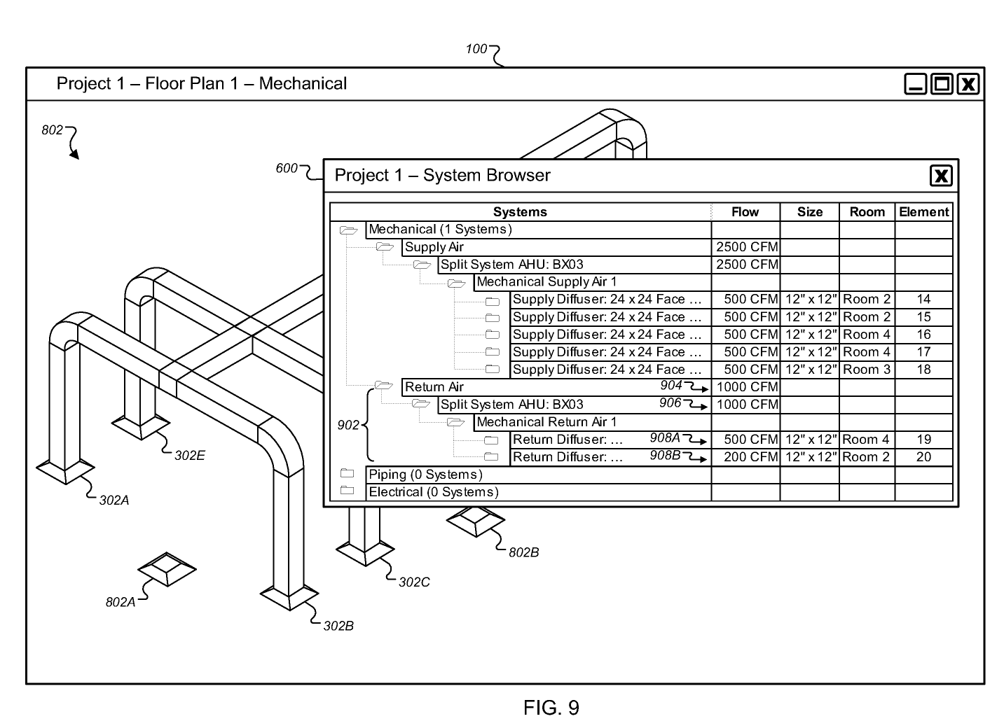

FIG. 9 shows a further example of the system browser 600 for viewing and manipulating properties of a flow system including return diffusers. The system browser 600 now includes a hierarchical representation 902 of the return airflow system. The representation 902 includes a total return air 904 represented by the return diffusers 802A-B, a return air capability 906 of the equipment 402, and return capabilities 908A-B of the return diffusers 802A-B, respectively.

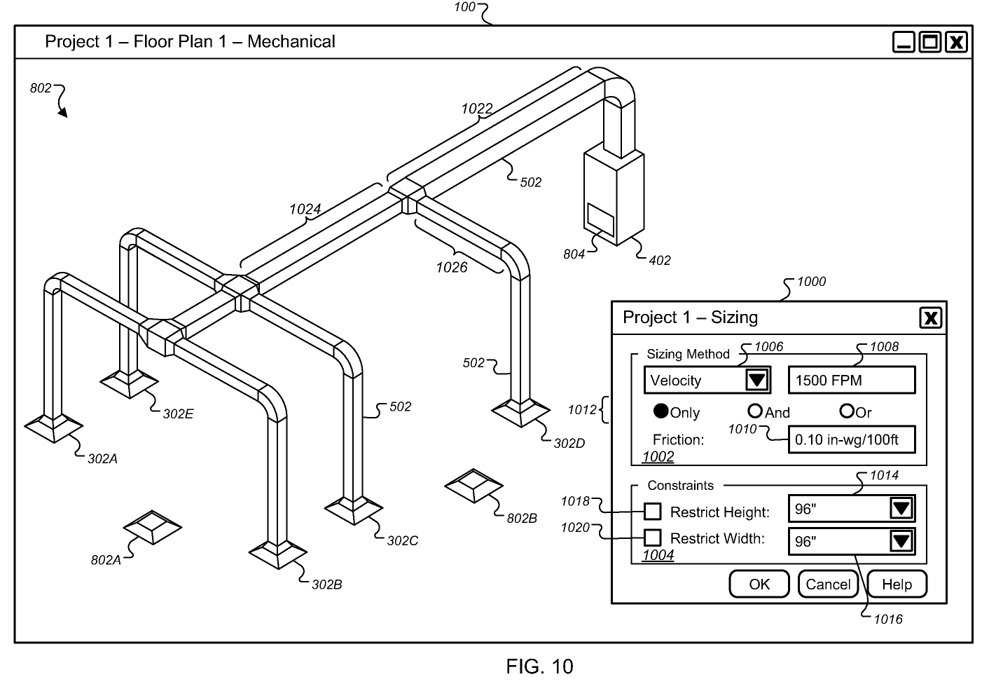

FIG. 10 shows an example of a properties dialog 1000 for automatically sizing one or more physical connections in a physical model of a flow system. A physical connection may be sized based on, for example, velocity, friction, and/or sizing constraints. By way of illustration, if a user makes the velocity higher in one duct than in other ducts, the higher velocity duct will automatically be resized to become smaller. Multiple physical connections or the entire flow system may be sized at once. In addition, if, for example, certain building constraints restrict the size or placement of physical connections, size constraints may be used to restrict the how large a physical connection can become. The sizes of physical connections may be held fixed while changing flow velocity or friction for the physical connections. This may automatically change the equipment to a particular piece of equipment capable of producing the determined flow velocity. In addition to sizing ducts and piping, fittings that connect ducts and piping can be automatically sized to accommodate changes in duct or piping size.

The sizing properties dialog 1000 includes sizing method options 1002 and sizing constraints 1004. The sizing methods 1002 can include input controls that allow users to define the method used to automatically size objects in a physical model for the flow system based on the analytical model.

For example, the user can specify a particular velocity of the flow in the system, such as 1500 feet per minute (FPM), using a velocity selection control 1006 and a velocity input control 1008. The user can also specify an amount of friction and whether friction will be used in calculating the sizing of objects, using an input control 1010. A Boolean selection control 1012 allows selection of sizing based, for example, on velocity only, friction only, velocity and friction, or velocity or friction. In addition, users may input the constraints 1004, such as a maximum height or width of objects, using input controls 1014 and 1016, respectively. A user may activate height and width restrictions using selection controls 1018 and 1020, respectively.

The 3D view 802 shows the results of automatically sizing the flow system. For example, a first section 1022 of duct objects has a first size resulting from the total flow rate and the selected velocity. A second section 1024 of duct objects has a second size and a third section 1026 of duct objects has a third size both resulting from their flow rate and the selected velocity. In this example, the sizes were chosen to maintain a velocity throughout the flow system that was specified using the velocity input control 1008.

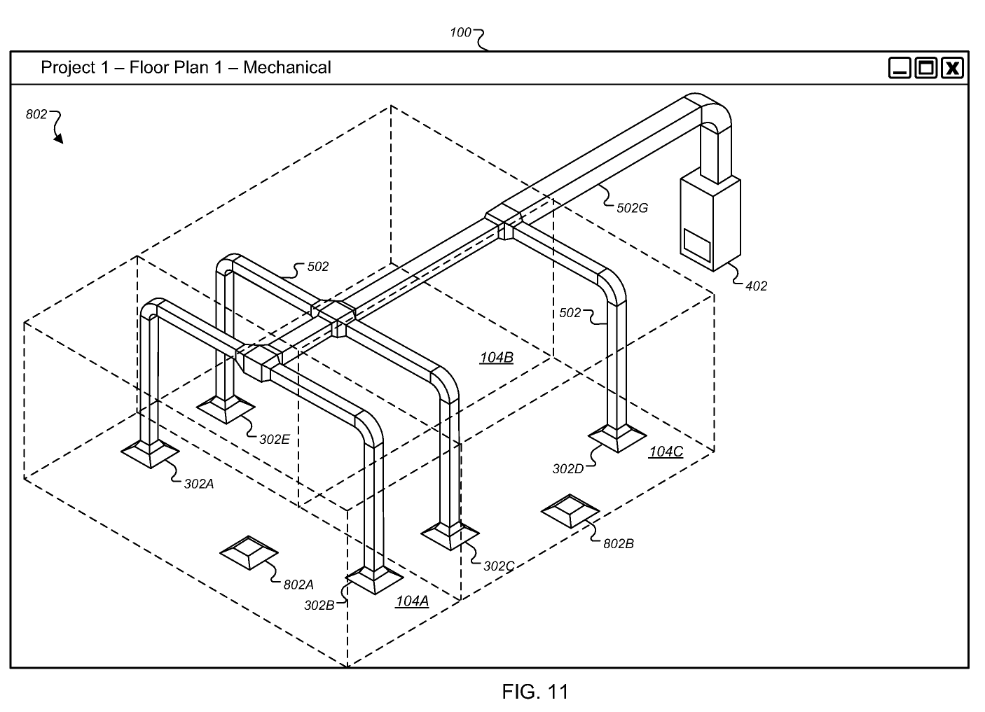

FIG. 11 shows automatically generated physical connections along with walls of the rooms 104A-C in the 3D view 802. Here, a user can determine, for example, that a default vertical distance of the supply diffusers 302A-E from the ductwork trunk in the ceiling places the supply diffusers 302A-E too close to the floor of the rooms 104A-C. In some implementations, floors, walls, and ceilings may be represented as solid faces. More elements of the surrounding structure may be shown, such as support columns, beams, and additional floors. The 3D view 802 or another view may allow a user to modify objects in the surrounding structure to accommodate elements of the flow system. For example, a hole may be made through the outer wall to allow the duct 502G to pass into the building.

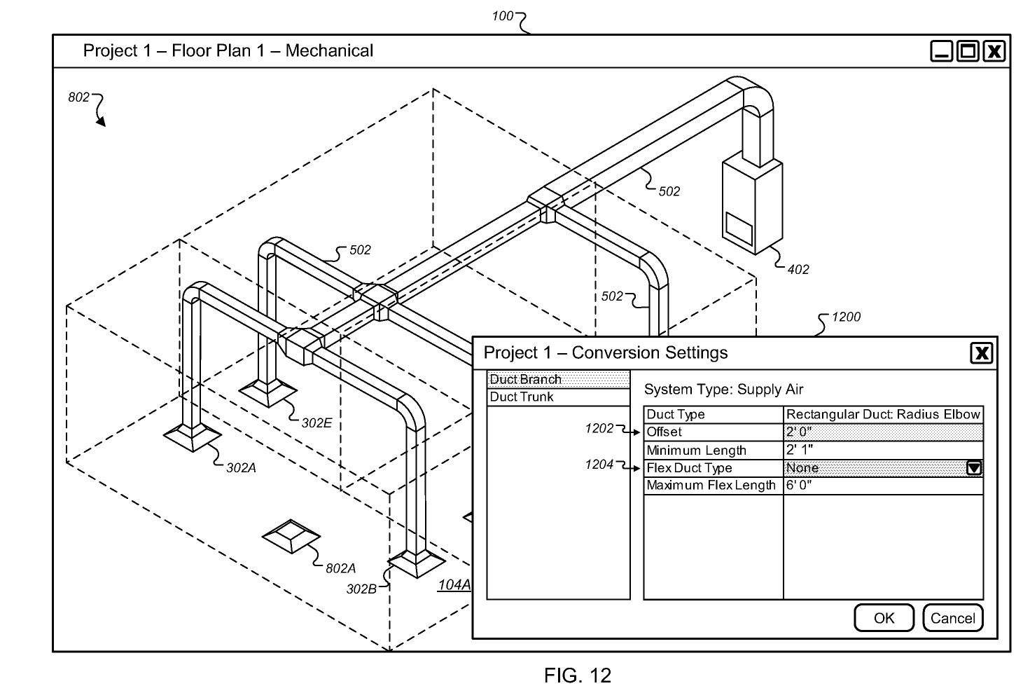

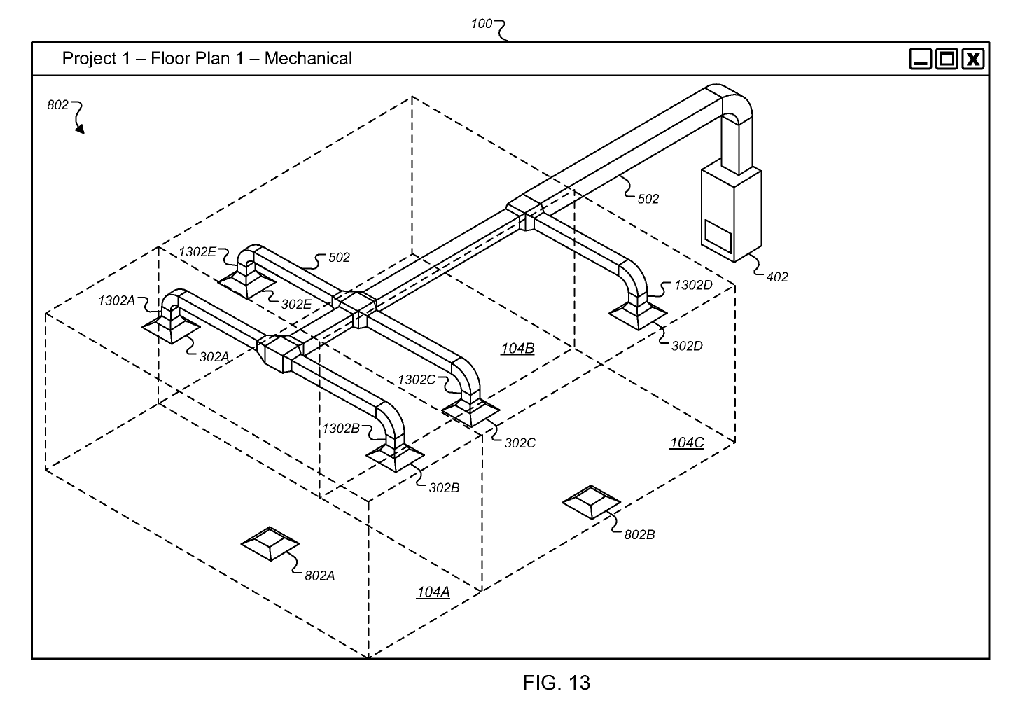

FIG. 12 shows an example of a conversion settings dialog 1200 for viewing, manipulating, and defining properties of one or more physical connections. Here, users can define, for example, the default distance 1202, or offset, of ducts (e.g., 502) from a level or floor. The defaults can be used to automatically generate objects. For example, the offset 1202 of two feet shown in the dialog 1200 places the ducts 2′0″ from the floor of the rooms. The offset 1202 may be changed to a larger value to raise the ducts, placing them closer to the ceiling as shown in FIG. 13.

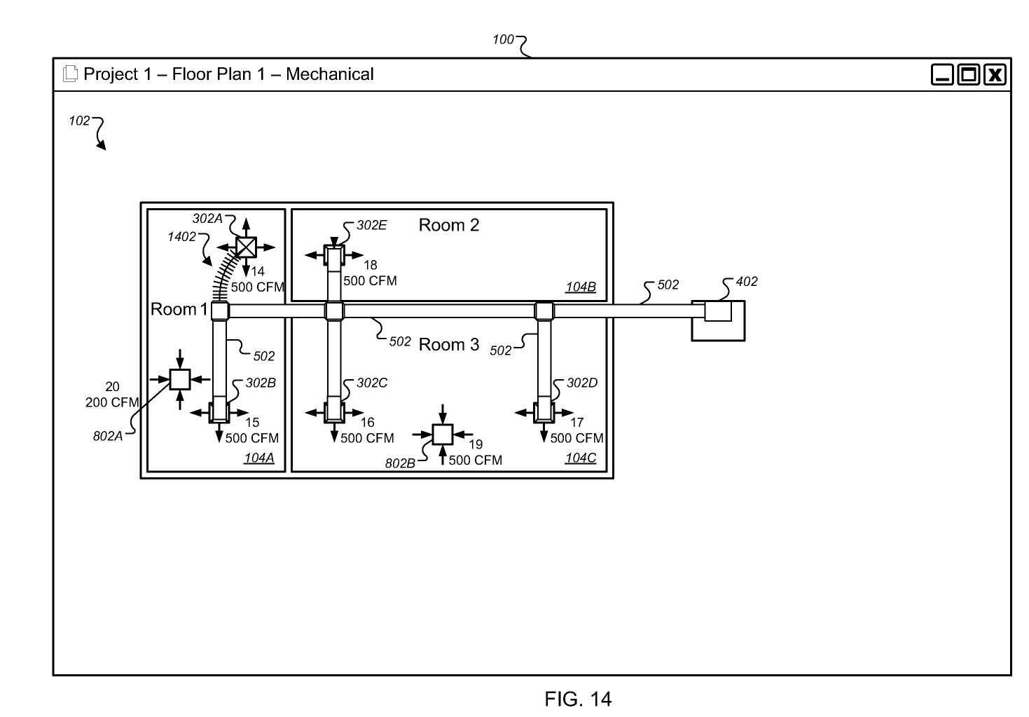

FIG. 14 shows an example of adding and modifying flexible physical connections. Here, a user has replaced the physical connection between the diffuser 302A and the trunk of the ductwork with a flexible physical connector 1402. The flexible physical connector 1402 allows a user to position the diffuser 302A freely within the room 104A without altering the routing of other ductwork. In some implementations, the interface 100 can use a maximum length of a flexible physical connector to limit the distance between a flow terminal connected to one end of the flexible physical connector and a object connected to the other end of the flexible physical connector.

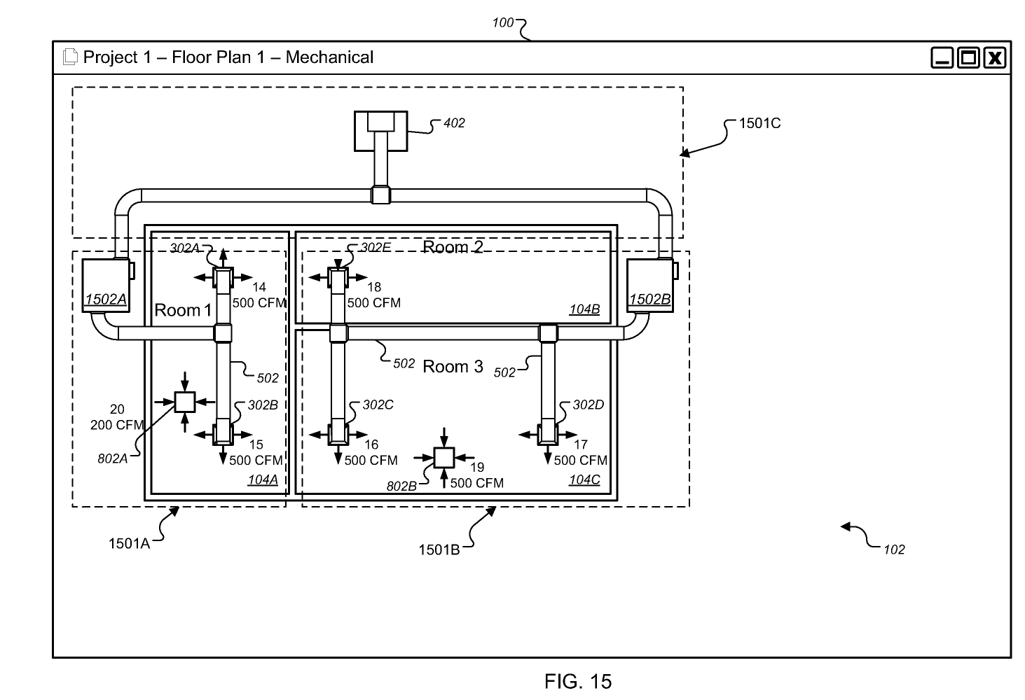

FIG. 15 shows an example of adding and modifying subsystems of a flow system. A flow system can incorporate one or more physical model flow subsystems. Here, the view 102 of the flow system 1501C includes two subsystems 1501A-B. Each of the subsystems 1501A-B has a fan powered variable air volume (VAV) piece of equipment (i.e., fans 1502A-B). The fans 1502A-B form a boundary between flow system 1501C and subsystems 1501A-B. In some implementations, the boundaries between subsystems may be arbitrarily defined. Inlets on the fans 1502A-B are connected to the supply of the AHU 402. The supply of the fan 1502A is connected to the supply diffusers 302A-B and the supply of the fan 1502B is connected to the supply diffusers 302C-E. The fan 1502A and the supply diffusers 302A-B form the subsystem 1501A of the flow system. The fan 1502B and the supply diffusers 302C-E form the subsystem 1501B of the flow system. Similarly, fluid flow systems and electrical systems can have subsystems.

A flow system, including its subsystems, can be analyzed to determine, for example, an amount of flow over time and a static pressure within the flow system, as described above. For example, the size of an object, the volume of flow through the object, and the velocity of the flow can be used to determine a static pressure within the object. Changes to an object can result in the analysis being performed again and a recalculation of the flow or static pressure. For example, the analytical model can represent each subsystem and propagate properties of a subsystem to another system interfacing with a connection point of the subsystem. Here, connection points on the fans 1502A-B propagate properties of the subsystems 1501A-B, respectively, to flow system 1501C and ultimately to the flow equipment 402.

In some implementations, an analysis of the entire flow system begins with each subsystem. The subsystems may be analyzed sequentially or concurrently. Analysis resulting from a subsystem may be propagated to a system that interfaces with the subsystem. The analysis may then proceed with the interfaced system, if its subsystems have been analyzed.

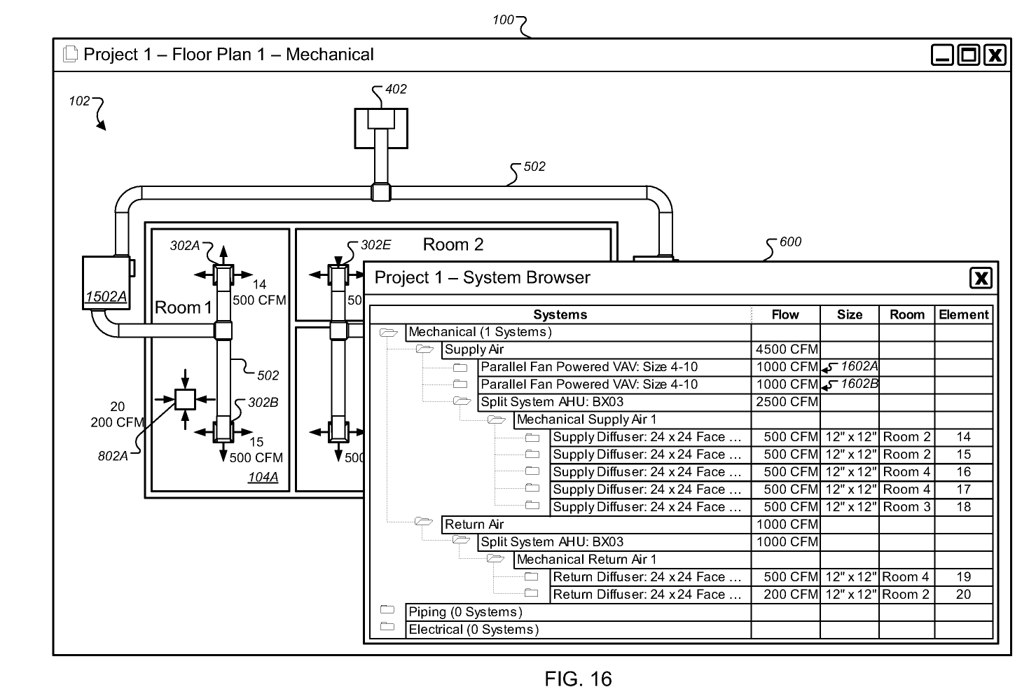

FIG. 16 shows another example of the system browser 600 for viewing and manipulating properties of a flow system including subsystems. Here, the interface 600 includes subsystem information, such as the supply flows 1602A-B of the fans 1502A-B, respectively. The total supply flow can be updated to reflect the addition of supply flow provided by the fans 1502A-B.

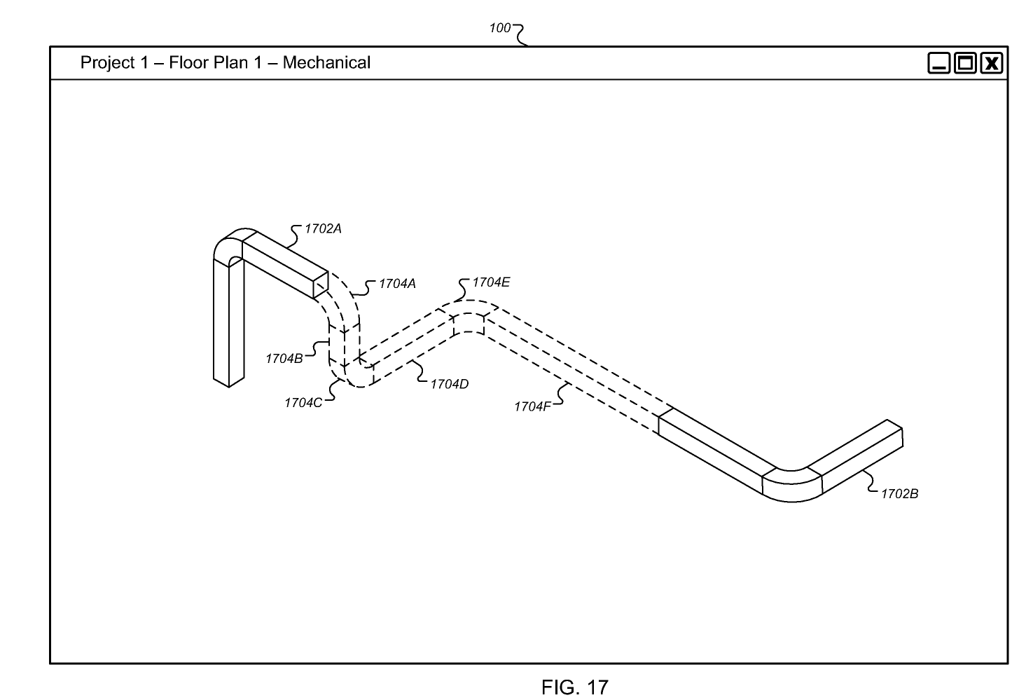

FIG. 17 shows an example of routing automatically generated physical connections. When automatically generating physical connections between objects, such as ductwork objects 1702A-B, heuristics or rules can be used to determine the routing of the physical connections between the objects. Here, a right-angle heuristic is used to route the physical connections 1704A-F between the objects 1702A-B. In other implementations, a different choice can be made at one or more of the junctions between the objects 1702A-B and the physical connections 1704A-F. For example, the physical connection 1704A can turn sideways toward the object 1702B instead of turning down toward the object 1702B with the other physical connections 1704B-F being adjusted accordingly. Physical connections can be automatically rerouted if a physical connection's position is changed. Moreover, if users create, modify (e.g., change position of or other properties) or delete physical connections, these changes will be automatically reflected in the analytical model.

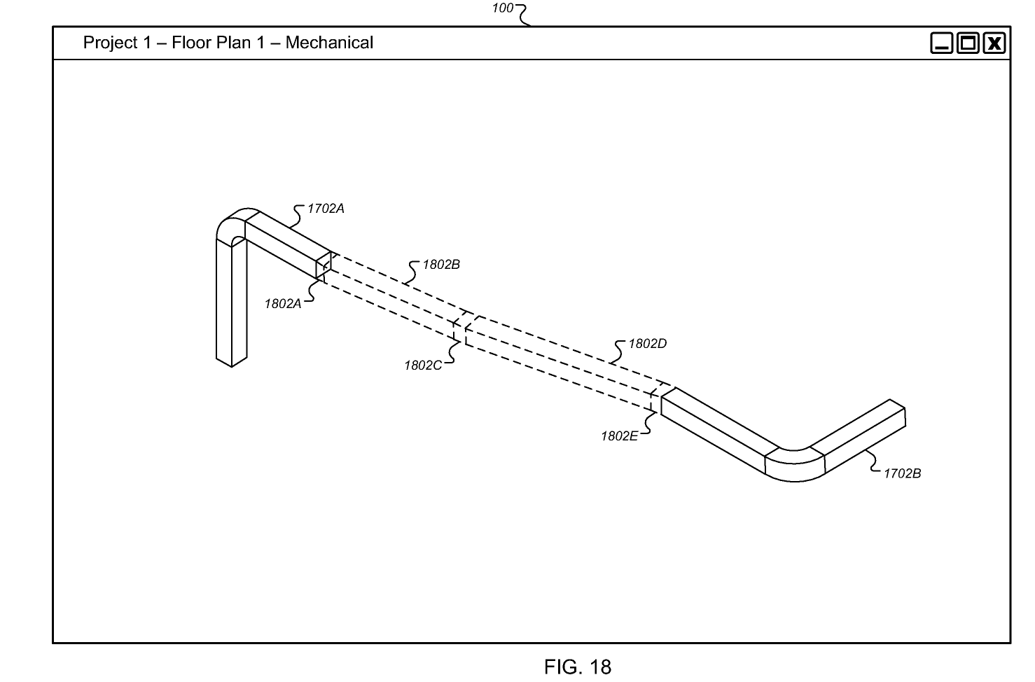

FIG. 18 shows another example of routing automatically generated physical connections. Here, a straight-line heuristic is used to route the physical connections 1704A-F between the objects 1702A-B. An attempt can be made to route the physical connections 1802A-E in a straight line between the objects 1702A-B. The physical connections 1802A-E can be limited, for example, by the maximum or minimum angles allowed by the flexible joints 1802A, 1802C, and 1802E. In some implementations, the structural elements within a CAD model, such as walls and supports, can be used to guide the routing of physical connections to avoid collisions with the structural elements. In some implementations, a combination of heuristics and structural information is used when automatically routing physical connections.

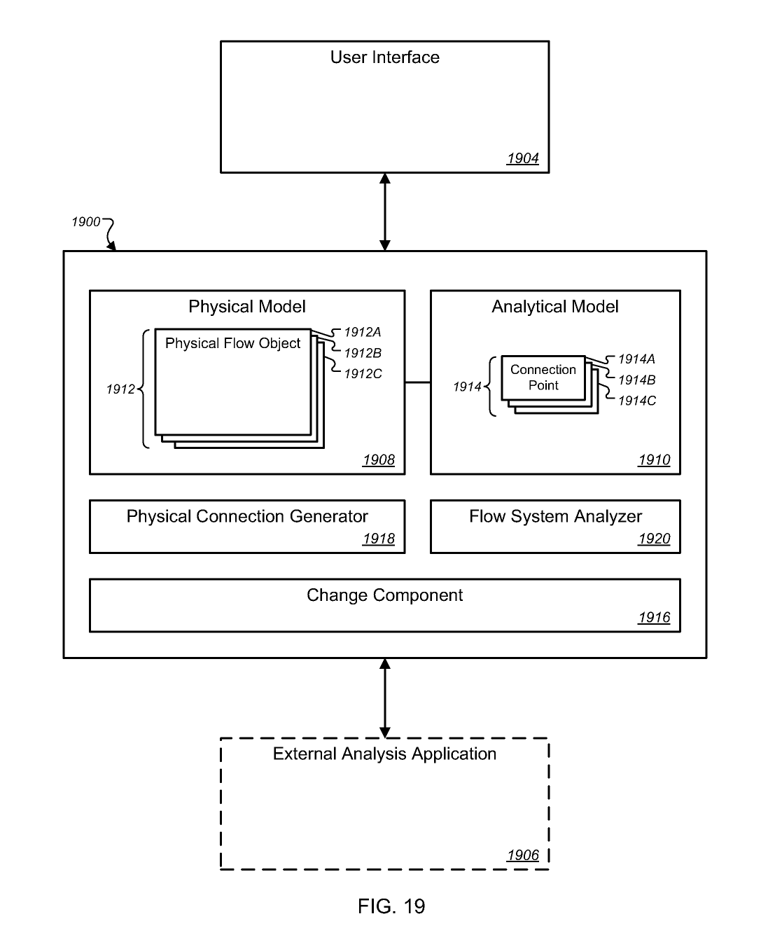

FIG. 19 is a system diagram of a CAD tool 1900 for viewing and manipulating a flow system. The CAD tool 1900 includes a user interface 1904, and optionally an external analysis application 1906. The CAD tool 1900 provides a physical model 1908 and an analytical model 1910 associated with the physical model 1908. The CAD tool 1900 presents the physical model 1908 and the analytical model 1910 to users via the user interface 1904.

The physical model 1908 and the analytical model 1910 can be imported into the CAD tool 1900, manually created using the CAD tool 1900, or a combination of these. The physical model 1908 includes one or more objects 1912. For example, the objects 1912 can include flow equipment, flow terminals, and physical connections. Flow equipment can provide a supply or return of flow, such as an HVAC unit, an exhaust fan, or a pump. Flow terminals can include elements, such as diffusers, return diffusers, or exhaust terminals. Physical connections can include elements, such as ducts, pipes, or fittings. The analytical model 1910 includes connection points 1914. Each object can be associated with one or more of the connection points 1914.

The CAD tool 1900 includes a change component 1916 capable of generating and updating the analytical model 1910 based on changes made to the physical model 1908, and vice versa. For example, a user may modify the analytical properties of a connection point using a properties dialog. One or more of the modified properties may influence one or more properties of one or more physical model objects. The change component 1916 updates the one or more physical objects based on the changes made to the analytical object. The CAD tool 1900 is also capable of automatically routing physical connections between flow terminals and flow equipment. For example, a physical connection generator 1918 may generate and route physical connections, such as ductwork and piping, between flow elements. The CAD tool 1900 includes a flow system analyzer 1920 capable of analyzing the flow system represented by the physical model 1908 and the analytical model 1910 to determine, for example, flow or static pressure for the flow system.

In some implementations, the physical model 1908 and/or the analytical model 1910 can be exported to the external analysis application 1906 to determine flow requirements for rooms. The flow requirements for the rooms can be imported into the physical model 1908 and used to size objects in the physical model 1908.

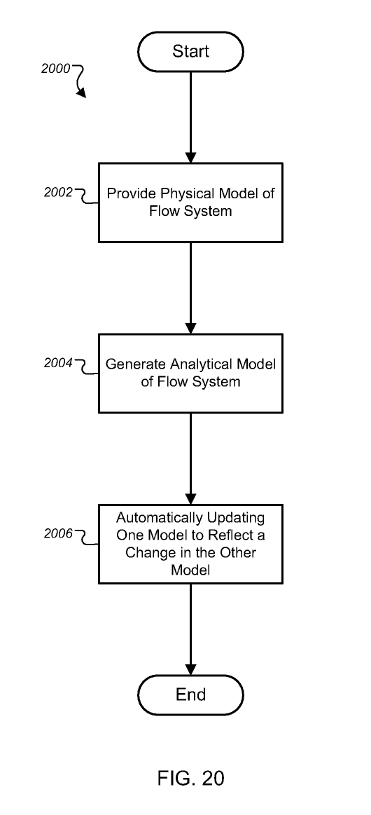

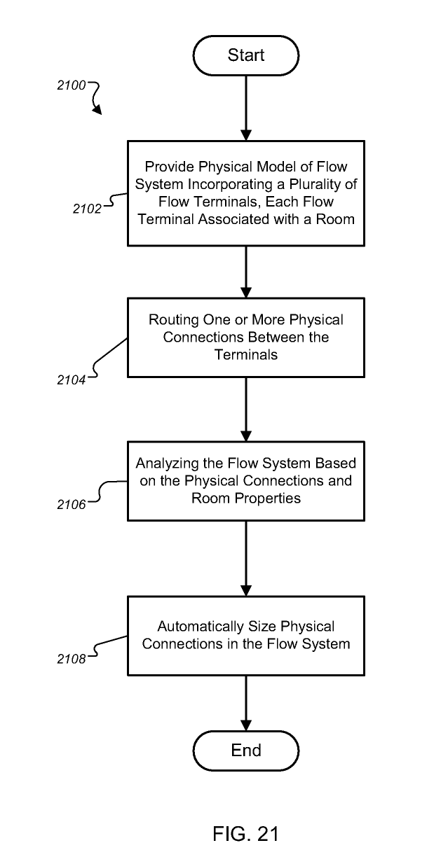

FIGS. 20 and 21 are flow diagrams of example techniques 2000 and 2100, respectively. The techniques 2000 and 2100 can be performed, for example, by a system such as the CAD tool 1900 and, for clarity of presentation, the descriptions that follow use the CAD tool 1900 as the basis of examples for describing the processes 2000 and 2100. However, another system, or combination of systems, can be used to perform the processes 2000 and 2100.

Referring to FIG. 20, the technique 2000 is an example of a process for generating and automatically updating an analytical representation of a flow system. At 2002, a physical model of a flow system is provided. The physical model includes physical objects in the flow system. Each of the physical objects can be to another physical object at a physical linkage point. An analytical model of the flow system is generated at 2004, along the connection points that can correspond to physical linkages. For example, the CAD tool 1900 can generate the analytical model 1910 associated with the physical model 1908. At 2006, one of the physical model or the analytical model is automatically updated to reflect a change in the other. For example, a user can modify the properties of a duct or change the location of the duct, and such changes will be automatically reflected in the analytical model 1910.

Referring to FIG. 21, the process 2100 is an example of a process for automatically routing physical connections in a flow system and analyzing the flow system. At 2102, a physical model of a flow system is provided. The physical model incorporates one or more flow terminals. Each of the one or more flow terminals is associated with a room. One or more physical connections are automatically routed, at 2104, between the flow system terminals. For example, the CAD tool 1900 can use the logical connections to determine routing from the equipment to the flow terminals. In some implementations, the routing is based on structural information in the physical model 1908 to avoid collisions with structural elements.

At 2106, the flow system is analyzed based on the physical connections and properties of each room. For example, the CAD tool 1900 can analyze the supply flow, return flow, and exhaust flows of a room to determine the flow and static pressure for the flow system. The CAD tool 1900 can use the flow and static pressure to automatically size physical connections in the flow system (step 2108).

Embodiments of the invention and all of the functional operations described in this specification can be implemented in digital electronic circuitry, or in computer software, firmware, or hardware, including the structures disclosed in this specification and their structural equivalents, or in combinations of one or more of them.

Embodiments of the invention can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer implemented method, comprising:
providing a physical computer aided design (CAD) model comprising a plurality of physical objects in a flow system, each of the plurality of physical objects joined at one or more physical linkages;
generating an analytical model of the flow system based on the one or more physical linkages; and
automatically updating one of the analytical model or the physical CAD model to reflect a change to the other.

2. The computer implemented method of claim 1, where:
the flow system is one of: an airflow system, a fluid flow system or an electrical system.

3. The computer implemented method of claim 1, further comprising:
performing an analysis of the flow system based on the analytical model.

4. The computer implemented method of claim 1, where:
the analysis includes determining flow, static pressure, velocity, or pressure loss.

5. The computer implemented method of claim 1, where:
a flow system incorporates one or more flow subsystems.

6. The computer implemented method of claim 1, further comprising:
determining a size for a physical object in the plurality of physical objects based on one or more of flow velocity, flow friction, or a size constraint.

7. The computer implemented method of claim 1, where:
a physical object is one of flow equipment, a diffuser, a return diffuser, an exhaust terminal, an exhaust fan, a duct, a pipe, an electrical cable or a fitting.

8. A computer implemented method, comprising:
providing a physical computer aided design (CAD) model of a flow system, the model incorporating one or more flow terminals and one or more rooms, each of the one or more flow terminals associated with a room in the one or more rooms;
automatically routing one or more physical connections between the flow system terminals; and
analyzing the flow system based on the one or more physical connections and one or more properties of each room.

9. The computer implemented method of claim 8, where:
the analyzing utilizes an analytical model; and
automatically updating one of the analytical model or the physical CAD model to reflect a change to the other.

10. The computer implemented method of claim 8, further comprising:
accepting user input designating the one or more flow terminals as the flow system.

11. The computer implemented method of claim 8, where:
analyzing includes determining flow or static pressure for the flow system.

12. The computer implemented method of claim 8, where:
the flow system includes flow equipment to provide water or air to, or extract water or air from, the flow system terminals.

13. The computer implemented method of claim 8, where:
a room property is one of: required airflow, required water flow, or required electrical current.

14. The computer implemented method of claim 8, where:
a flow terminal is one of: a diffuser, a return diffuser, an exhaust terminal, an exhaust fan, a cooling coil, or a heating coil.

15. The computer implemented method of claim 8, where:
a physical connection is a duct, a pipe, and electrical cable or a fitting.

16. The computer implemented method of claim 8, further comprising:
determining a size for a physical connection in the one or more physical connections based on one or more of flow velocity, flow friction, or a size constraint.

17. A computer program product, encoded on a computer-readable medium, operable to cause data processing apparatus to perform operations comprising:
providing a physical computer aided design (CAD) model comprising a plurality of physical objects in a flow system, each of the plurality of physical objects joined at one or more physical linkages;
generating an analytical model of the flow system based on the one or more physical linkages; and
automatically updating one of the analytical model or the physical CAD model to reflect a change to the other.

18. The computer program product of claim 17, where:
the flow system is one of: an airflow system, a fluid flow system or an electrical system.

19. The computer program product of claim 17, further operable to cause the data processing apparatus to perform operations comprising:
performing an analysis of the flow system based on the analytical model.

20. The computer program product of claim 17, further operable to cause the data processing apparatus to perform operations comprising:
determining a size for a physical object in the plurality of physical objects based on one or more of flow velocity, flow friction, or a size constraint.

21. A computer program product, encoded on a computer-readable medium, operable to cause data processing apparatus to perform operations comprising:
providing a physical computer aided design (CAD) model of a flow system, the model incorporating one or more flow terminals and one or more rooms, each of the one or more flow terminals associated with a room in the one or more rooms;
automatically routing one or more physical connections between the flow system terminals; and
analyzing the flow system based on the one or more physical connections and one or more properties of each room.

22. The computer program product of claim 21, where:
the analyzing utilizes an analytical model; and
further operable to cause the data processing apparatus to perform operations comprising automatically updating one of the analytical model or the physical CAD model to reflect a change to the other.

23. The computer program product of claim 21, further operable to cause the data processing apparatus to perform operations comprising:
accepting user input designating the one or more flow terminals as the flow system.

24. The computer program product of claim 21, where:
analyzing includes determining flow or static pressure for the flow system.

25. The computer program product of claim 21, where:
the flow system includes flow equipment to provide water or air to, or extract water or air from, the flow system terminals.

26. The computer program product of claim 21, where:
a room property is one of: required airflow, required water flow, or required electrical current.

27. The computer program product of claim 21, where:
a flow terminal is one of: a diffuser, a return diffuser, an exhaust terminal, an exhaust fan, a cooling coil, or a heating coil.

28. The computer program product of claim 21, where:
a physical connection is a duct, a pipe, and electrical cable or a fitting.

29. The computer program product of claim 21, further operable to cause the data processing apparatus to perform operations comprising:
automatically determining a size for a physical connection in the one or more physical connections based on one or more of flow velocity, flow friction, or a size constraint.
